(19) United States
(12) Patent Application Publication
(10) Pub. No.: US 2025/0060083 A1
(43) Pub. Date: Feb. 20, 2025

(54) Lighting Device

(71) Applicant: Bernd Ballaschk, Burg/Spreewald (DE)

(72) Inventor: Bernd Ballaschk, Burg/Spreewald (DE)

(21) Appl. No.: 18/686,203

(22) PCT Filed: Aug. 26, 2022
(86) PCT No.: PCT/EP2022/073834

§ 371 Date: Feb. 23, 2024

(30) Foreign Application Priority Data
Aug. 26, 2021 (DE) 10 2021 122 149.8

(51) Int. Cl. F21V 3/04; F21V 7/06; F21W 111/00; F21Y 103/33; F21Y 107/50; F21Y 115/10

(52) U.S. Cl. CPC F21V 3/049; F21V 7/06; F21W 2111/00; F21Y 2103/33; F21Y 2107/50; F21Y 2115/10

(57) ABSTRACT

The application relates to a lighting device (10), in particular a beacon light or an obstruction warning light, comprising a base (14) on which a group of a plurality of light sources (23) is arranged in a horizontal plane (H), and a transparent cover (13) which surrounds the light sources (23) and is designed to protect the light sources (23) from environmental impacts. At least some of the light sources (23) are arranged eccentrically to a zenithal axis (Z) that runs perpendicularly to the horizontal plane (H) and defines a vertical direction. The cover (13) has a calendered inner face (87) and/or outer face (88).

The present invention relates to a lighting device, in particular a beacon or obstruction light, often also simply called a “light”.

The lighting of obstacles, landmarks and equipment is of significant importance for safety in aviation and shipping. The requirements for beacons are defined in national regulations and international agreements. For example, a red color is required for obstruction lights for night visibility. An infrared (IR) signature can be provided for visibility by night vision devices. Furthermore, obstruction lights should generally provide a specified light intensity over the entire horizontal angle range (e.g. 360° for all-round light, 180° for half-space radiation) in a limited vertical angle range. Lights of this type are usually fitted with LEDs (light emitting diodes). These are arranged as a lighting unit on a base and surrounded by a transparent cover. Individual optics or common optics are often used to focus the light emitted by the LEDs as approximate Lambert spotlights, which are generally hemispherical. As the LEDs are perceived as point-shaped light sources, the light emitted by several LEDs has a ripple with pronounced minima and maxima over the irradiated area. To reliably achieve the required luminous intensity even in the minima, LEDs are used in the appropriate power and number. This is associated with the corresponding manufacturing costs, lamp consumption and corresponding power consumption. The particularly high luminosity in the maxima can be perceived as disturbing.

One task of the present invention is therefore to create a lighting device, in particular a beacon or obstacle beacon, which enables uniform radiation, high overall light output, low power consumption, low manufacturing costs and low operating costs.

The above-mentioned task is solved at least in partial aspects by the features of claim 1. Advantageous further developments and preferred embodiments form the subject matter of the subclaims.

A lighting device, in particular a beacon or an obstruction light, comprising: a base on which a group of several light sources is arranged in a horizontal plane, and a transparent cover surrounding the light sources and adapted to protect the light sources from environmental influences, wherein at least some of the light sources are arranged eccentrically to a zenith axis orthogonal to the horizontal plane and defining a vertical direction. According to the invention, the cover has a frosted inner and/or outer surface.

A lighting device is any type of lighting of an obstacle, a landmark or a device. It can be all-round or over a selected angular range, continuous or intermittent, fixed or rotating. The direction used, such as horizontal, vertical, azimuth, zenith, etc. are generally related to the lighting device, i.e. they are local self-directions, but can coincide with general directions of the environment when used. A base can have any shape if the light sources of a group can be arranged on it along the horizon plane and can radiate in the desired direction. For example, the base can be flat or curved, such as cylindrical or part-cylindrical or spherical, in particular spherical or spherical segment shaped. For the inventors, transparency is understood to mean a light transmission of more than 0, in particular at least 60%, preferably at least 80% in relation to the light intensity, whereby 100% corresponds to an unglazed surface. The fact that the cover is transparent is to be understood as meaning that the cover has a transparent body that surrounds the light sources but can also comprise other elements or non-transparent sections. It is essential that the cover allows light from the light sources arranged on the inside to pass through to the outside. The inner side is a side or surface facing the light sources, and the outer side is a side or surface facing an external space, i.e., facing away from the light sources. The permeability of a glazing is not a mere material constant, but depends not only on the material properties, but also on thickness, angle of incidence, wavelength and kind of surface. Unless explicitly stated otherwise, the specified numerical values for transparency refer to the wavelength range of the light sources used and to vertical incidence. For the purposes of the invention, a satin finish is understood to mean a surface roughening with structures that are large enough to have a scattering effect on the light used, but not so large that they would bundle or defocus the light and thus function as an optical imaging element themselves. The appropriate dimension of the structures generally depends on the wavelength of the light.

On the one hand, the frosting achieves a more diffuse emission, which avoids undesirable maxima and minima in the azimuthal brightness distribution. In addition, the frosting reduces reflection phenomena in the interior of the cover as well as within the transparent wall of the cover, so that the light output itself increases overall. This makes it possible to operate the light with lower power consumption and to design the light with fewer or less powerful LEDs, thereby reducing manufacturing and operating costs. The requirements of the applicable standards continue to be met.

It may also be provided that the light sources of the group of light sources have overlapping emission areas in the horizontal plane. This can also further improve and equalize the coverage of the required angular range. In particular, overlapping edge emission areas can compensate for the drop in the respective intensity maxima of the respective light sources. As this compensation occurs within the group of light sources arranged in a horizontal plane, the overall deviation of the radiation in the elevation direction can be further minimized.

The effect of the invention is particularly pronounced if the cover is rotationally symmetrical around the zenith axis. For example, the cover can be cylindrical or bell-or dome shaped or partially cylindrical or partially bell-or partially dome shaped.

In embodiments, it may be provided that the light sources of the group of light sources are arranged on a circular line or part of a circular line around the zenith axis. The angular distances between the light sources are preferably the same. This ensures that the required angular range in the horizontal plane is reliably covered.

The light sources can be designed in such way that they emit light over an angular range of at least 45° and in particular at least 90° in the horizontal plane. If such a light source is arranged eccentrically to the vertically aligned zenith axis, the proportion of rays that hit the cover flat is greater with increasing eccentricity and the degree of flatness, and thus the angle of incidence on the inside of the cover, is also greater. This also increases the influence of the frosting and thus the effect of the present invention. This is all the truer, the larger the angular range over which the light sources radiate, particularly in the case of Lambert spotlights, such as those approximately realized by light-emitting diodes.

If the light sources are light-emitting diodes, a desired wavelength range, i.e., a desired color shade, can also be displayed well.

It is preferable for the group of light sources to have three or at least four, preferably six or eight, light sources. The number of light sources determines the brightness distribution of the light originally emitted by the group of light sources, the total amount of light, any color mixing, but also the amount of equipment, the power consumption and the ongoing operating costs.

In embodiments, it may be provided that the light sources or the lighting device emit a total of red light in a wavelength range of at least 605 nm and not more than 780 nm and/or infrared light in a wavelength range of at least 780 nm and not more than. A light emission in the red color range corresponds to the usual requirements of aviation or shipping standards. The red light can also have a wavelength range of at least 610 nm or at least 615 nm and/or not more than 730 nm or not more than 710 nm or not more than 690 nm or not more than 620 nm. The red light may also cover a wavelength range of, for example, 608-617 nm or 610-700 nm or 607-620 nm to meet certain technical standards. The emission of a light with an infrared signature facilitates detectability by night vision devices. The infrared light may also comprise a wavelength range of at least 830 nm and/or a wavelength range of not more than 1000 nm. The infrared light can also comprise a dominant wavelength of 850 nm or 940 nm. The numerical values mentioned are purely exemplary and can be freely selected depending on the requirements. It is also understood that the invention is also applicable to lights with other color choices, for example orange (about 595 to 605 nm), yellow (about 570 to 585 nm), green (about490 nm to 550 nm, blue (about 445 to 475 nm) or white. However, for beacons and obstruction lights, light in the far-red range around 725 nm or between 705 and 735 nm is typically used, as the eye sensitivity is particularly low there. All specified limits are to be understood as meaning that at least 50% or at least 60% or at least 70% or at least 80% of the emitted radiant energy occurs within the specified range.

In embodiments, it may be provided that the lighting device comprises an optical element for directing the light emitted by the light sources onto the cover, which is designed to focus the light on the vertical direction. In other words, optical element essentially deflects the light emitted by the light sources into the horizontal plane. As a result, the luminous intensity required by applicable standards can be realized in the vertical angular range defined there. A suitable design of the optical element can ensure, for example, that the light is focused to an angular range of −2° to 10° in the vertical direction. In the context of the application, focusing is understood to mean that at least 50% of the emitted radiation occurs in the specified range. The optical element may comprise a reflector and/or a refractor or lens. For example, the optical element may comprise a plurality of individual optics, wherein each individual optics is assigned to one of the light sources and is configured to focus the light in the vertical direction of the light source, wherein the individual optic covers and surrounds a light-emitting region of the light source. In other words, attachment lenses can be used that are placed on each light-emitting diode and have corresponding interfaces, which deflect and focus the emitted light into the desired horizontal area. Such individual optics can, for example, be so-called side emitter optics. On the other hand, the optical element can comprise a common reflector or refractor that is designed to bundle the light emitted by several or all of the light sources in the vertical direction. The common reflector can, for example, comprise a reflection surface, which is a surface of revolution with a parabolic or approximately parabolic cross-section, in the focal line of which the light sources, in particular light-emitting diodes, are arranged. Depending on the desired vertical aperture angle, the cross-sectional shape of the reflective surface can also deviate slightly from a perfect parabola and/or the light sources can also be positioned slightly out of focus. If the light sources are arranged on a flat surface that runs along the horizontal plane, only one branch of the parabola can advantageously be used to focus the light.

The frosting of the cover can be formed by sandblasting or compressed air blasting with another solid blasting abrasive or by grinding or etching. Other solid blasting abrasives that can be used include corundum or glass beads.

In embodiments, it may be provided that the frosting is formed with structures in the dimension of at least 0.1 μm or at least 0.2 μm or at least 0.5 μm or not less than 1 μm. Furthermore, it may be provided that the frosting is formed with structures in the dimension of not more than 3 μm is not more than 1.5 μm or not more than 1.3 μm or not more than 1 μm. The specified limits are to be understood within the framework of technically unavoidable fluctuation margins. The appropriate dimension of the structures will depend, among other things, on the wavelength of the light in question. If the structures are much smaller than the wavelength of the incident light, they will have no or negligible effect. If the dimension of the structures approaches or significantly exceeds the wavelength of the light, the structures will increasingly function as independent optical imaging elements. This is undesirable in the context of the invention unless other desired effects can be achieved.

For example, the frosting can be oriented in a vertical direction. In other words, a preferred direction of the structures provided by the frosting can be provided in the vertical direction. This makes it possible to avoid scattering in the vertical direction, so that the desired concentration on the horizontal plane is maintained or improved.

In embodiments, several of groups of light sources can be provided, each arranged in a horizontal plane, the horizontal planes of the groups being spaced parallel along the zenith axis. By stacking several groups of light sources along the zenith axis in this way, a multiplication of the light intensity can be achieved without changing the basic structure.

In embodiments, it may be provided that the base has a surface formed along the horizontal plane on which the light sources of the or a group of light sources are arranged. In other words, the light sources radiate parallel to the surface of the base. Such an arrangement also enables a particularly plain design of the lighting device.

In embodiments, it may also be provided that the base has a cylindrical or partially cylindrical surface formed along the zenith axis or several flat surfaces formed parallel to the zenith axis, on which the light sources are arranged. In other words, the light sources are arranged on a surface perpendicular to the horizontal plane, i.e., to the desired direction of radiation or main direction of radiation. The multiple flat surfaces parallel to the zenith axis can be arranged along a cylindrical surface and thus simulate a cylindrical or partially cylindrical surface piece by piece. Any optical elements for bundling the light emitted by the light sources in the vertical direction can then be adapted to this application.

The cover can be made of any suitable material that is permeable to light or at least the light of the desired wavelength. For example, the Cover can be made of a polyacrylic or polycarbonate or polymethyl methacrylate or polymethacrylmethylimide or polystyrene or styrol-acrylnitril copolymer or cycloolefin copolymer or other transparent plastic or quartz glass or another mineral glass.

In embodiments, an interior space within the cover can be filled with a translucent potting compound. The potting compound can enclose the light sources. If necessary, the potting compound can also enclose the base on which the light sources are arranged. Such a potting compound can prevent water or moisture or other foreign substances from penetrating the interior of the cover even more effectively. This can extend the life of the light sources and also improve operational safety. It can also enable use in harsh environmental conditions, such as offshore or even underwater. As a potting compound generally has a higher thermal conductivity than air when hardened, the heat of the light sources and the electronics that control and supply the light sources can also be improved via the potting compound and the cover, if necessary, this can be fully implemented in this way. As a result, other cooling elements can also be made smaller or may be completely dispensable. Heating the cover via the potting compound can prevent fogging and/or frost formation on the cover, which can also make additional heating unnecessary. The potting compound can be solid overall, but have an elasticity that minimizes stresses and strains on the light sources and the cover, even under thermal loads or external influences. The potting compound can be crystal clear, as a result of which, apart from an unavoidable but low light absorption within the potting compound, the light has approximately the same advantages as an empty cover, i.e. One filled with air, if this has the described frosting according to the invention on the other hand, the potting compound can comprise a certain milkiness, i.e., an inclusion of fine particles or bubbles that cause a diffuse scattering of the light as it passes through. In such a case, the light output may decrease, but on the other hand, the uniformity of the light emission can be improved under certain circumstances. A potting compound is understood to mean a material that is capable of flow at least to the extent that it is capable of filling a volume under pressure or gravity and loses its capability of flowing largely and irreversibly as a result of a chemical reaction or a mechanical or physical process, possibly under the influence of light, heat, cold or simply ambient air. This process is also called hardening. Such a potting compound can, for example, be made from a resin and a hardener, which are filled together and then harden. For example, the resin can be a polyurethane resin.

The invention makes it possible to create a lighting device with a more uniform light output and an increased overall light output, which enables considerable savings to be made in production and operation. Legal requirements and technical standards regarding light intensity and bundling can be adhered to.

Further advantages, tasks and details of the invention will become apparent from the following description in conjunction with the attached drawing. In this connection,

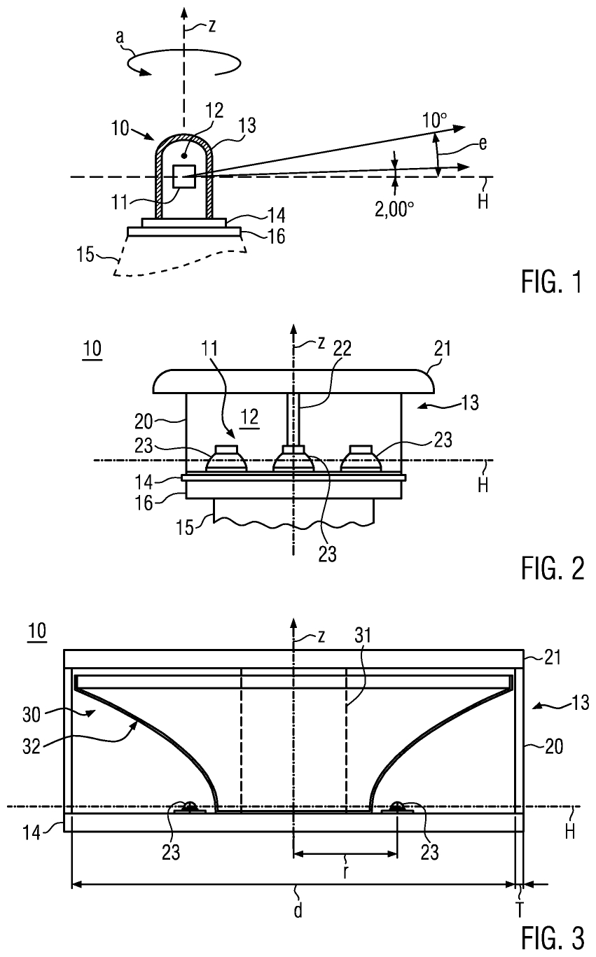

FIG. 1 is a schematic diagram of a lighting device in vertical section;

FIG. 2 is a side view of a lighting device with cylindrical cover;

FIG. 3 is a side view of a lighting device with cylindrical cover and side reflector;

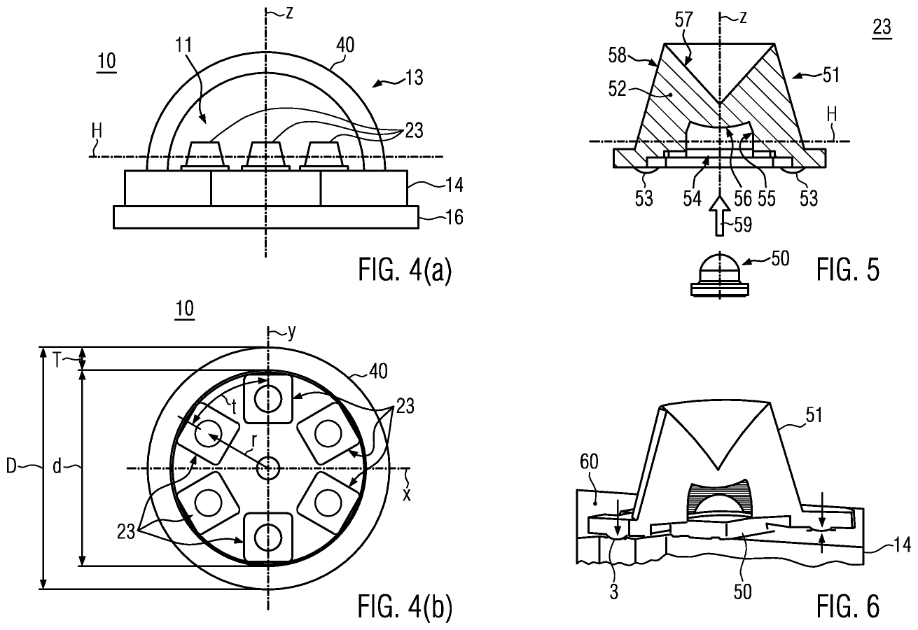

FIG. 4 is a lighting device with dome shaped cover in vertical section (a) and horizontal section (b);

FIG. 5 is an assembly diagram of alight-emitting diode with a side emitter optics in vertical section;

FIG. 6 is a light-emitting diode with side emitter optics on a base in partial vertical section;

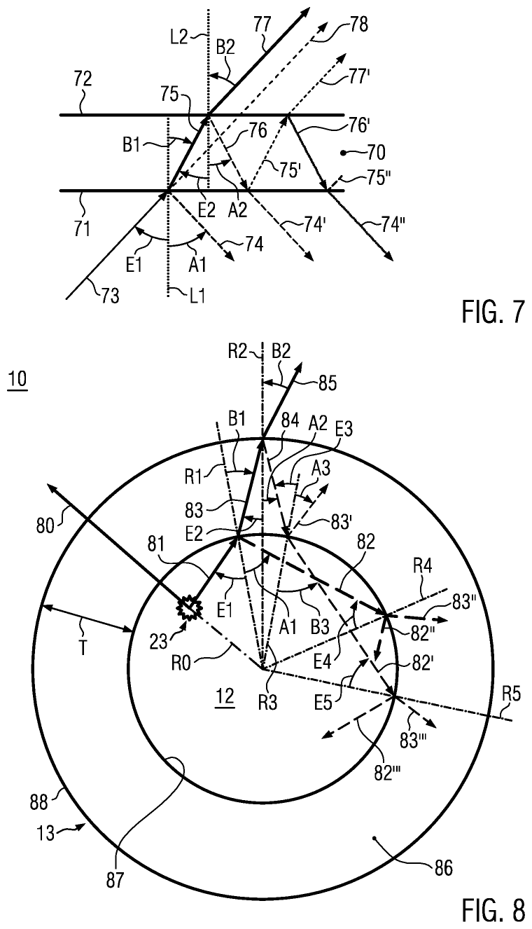

FIG. 7 is a schematic diagram illustrating a for explaining a radiation passing through a transparent flat wall;

FIG. 8 is a schematic diagram illustrating a radiation passing through a transparent cylindrical wall with an eccentrically arranged light source;

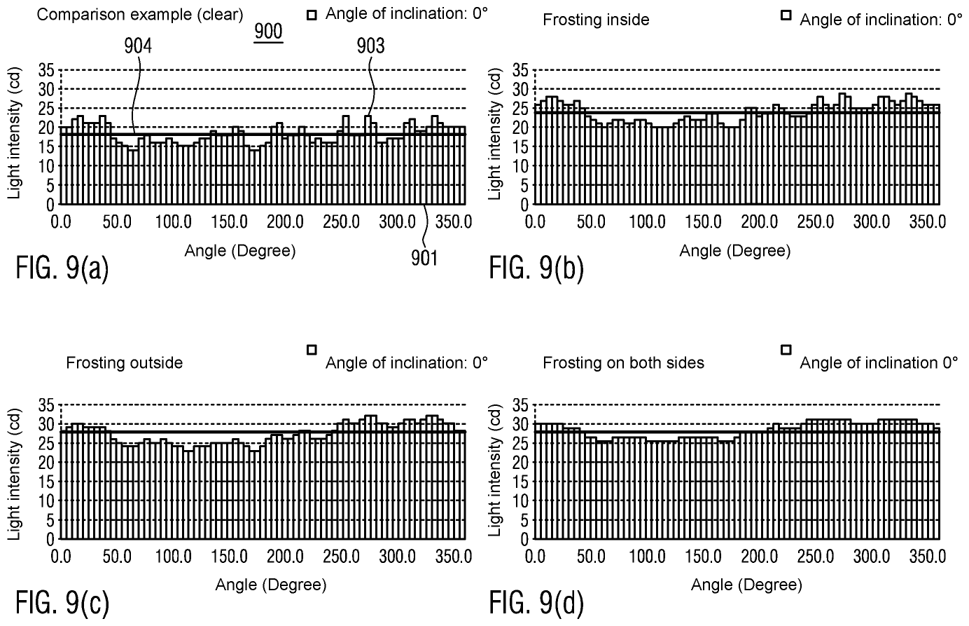

FIG. 9 Diagrams of a measurement of a light intensity of a light emitted from a lighting device over 360° in the horizontal plane in a comparative example with clear cover (a) and embodiments of the invention with frosting on the inside (b), on the outside (c) and on both the inside and outside (d);

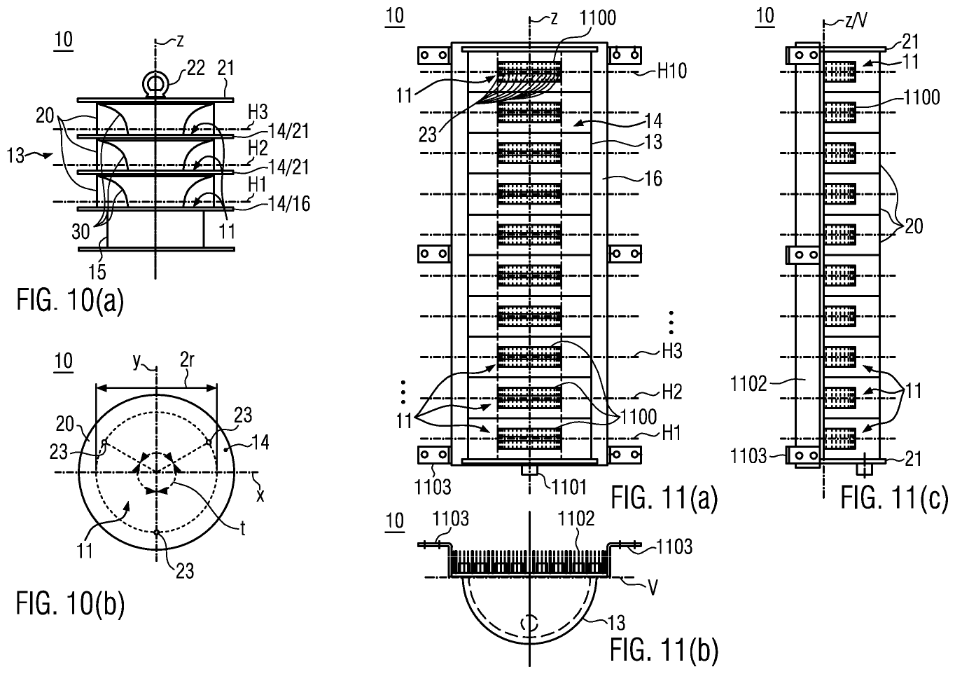

FIG. 10 a lighting device with several light units arranged one above the other in vertical section (a) and horizontal section (b) in a horizontal plane;

FIG. 11 a lighting device comprising several light units arranged one above the other for half-sided radiation in the front view (a), top view (b) and side view (c).

The figures are purely schematic and made to illustrate the invention. The figures are not intended for the acceptance of specific dimensions, unless explicitly indicated.

A lighting device 10 has a lighting unit 11 which is arranged in an interior 12 of a cover 13 (FIG. 1). The lightning unit 11 and the cover 13 are arranged on a base 14. The base 14 can be arranged on a housing 15 with a cover plate 16. The housing 15 can accommodate a switch panel for controlling the lighting unit 11 and/or a supply unit for supplying the lighting unit 11 with electrical energy. The lighting device comprises a horizontal plane H and a zenith axis Z extending at right angles to it. An angle around the zenith axis Z is an azimuth angle a, and an angle rising from the horizontal plane H is an elevation angle e. The horizontal plane H defines a local horizon of the lighting device, and the zenith axis Z defines a local vertical of the lighting device 10. The horizon plane H can coincide with a global horizontal, and the zenith axis Z can coincide with a global vertical. Without limiting the generality, this can be the code case in a real installation situation. For the purposes of this disclosure, “up” is defined as a direction in the zenith direction (+Z), “down” as a direction opposite of the zenith direction (−Z), and “laterally” as a direction radial from the zenith axis Z, irrespective of the actual current orientation of the lighting device 10 in the area.

Obstruction lights are generally omnidirectional beacons with a horizontal beam angle range of 360°. Partial beacons can cover a smaller horizontal beam angle range of, for example, 180° or less or more. According to current standards, the light intensity must be within a specific vertical angle range of the elevation e in relation to the horizontal plane H. For example, this vertical angle range can be −2° to +10° (positive elevation e measured to zenith Z).

The cover 13 is transparent. This means that the cover is at least partially transparent to light in general or to light of a selected wavelength range in particular. In addition to quartz glass or other mineral glasses, the cover 13 can be made of a polyacrylic or polycarbonate or polymethyl methacrylate or polymethacrylmethylimide or styrol-acrylnitril-copolymer or cycloolefin copolymer or another transparent plastic. Such glasses or artificial glasses generally comprise a light transmission of at least 80% in relation to the light intensity at vertical incidence of light compared with an unglazed surface, but the invention is not limited to this, but can also be applicable to materials with a lower transparency.

The cover 13 can, for example, comprise a transparent hollow cylindrical or tubular body 20 as the area relevant for the light transmission (FIG. 2). The tubular body 20 can be closed at the top by a cover plate 21. The cover plate 21 can be secured with a screw 22 opposite to the base 14. The cover plate 21 can be opaque. Alternatively, the cover can also comprise a cylinder body, which is drilled or milled or turned out or otherwise hollowed out on one side from the rear side to form the interior 12, so that no separate cover plate is required (not shown in detail). In the latter case, the remaining end face can be opaque coated.

In another embodiment, the cover 20 may have a transparent dome-shaped or bell-shaped body 40 (FIG. 4(a)).

The light unit 11 generally comprises a group of light sources 23 that are arranged at the base 14 along the horizontal plane H. At least one, in the example shown all, of the light sources 23 is arranged eccentrically with respect to the zenith axis Z. That is, the light sources 23 comprise a radial distance r from the zenith axis Z (FIG. 4(b)). Without limiting the generality, the light sources are arranged in a uniform angular distance or pitch angle T.

The light source 23 used are often Lambert spotlights or approximate Lambert spotlights such as light-emitting diodes (LEDs). These have a hemispherical or approximately hemispherical radiating range. If such a light source 23 is arranged on a plane such as the base 14, a large part of the emitted light radiation would be emitted upwards. This is often undesirable, especially in the case of obstruction fires, where lateral radiation is particularly important. To direct the emitted light radiation into the horizontal plane H, an optical element can be used to focus the emitted light radiation vertically. The optical element can, for example, be a reflector 30, which focuses the light of all light sources 23 (FIG. 3). The reflector can comprise a reflective surface 32, which is formed around the zenith axis Z, for example, as a surface of revolution with a parabolic or approximately parabolic cross-section. If the light sources 23 are arranged in a focal point line that is defined by the focal points continuously following one another in the direction of rotation of the reflective surface 32, the reflective surface 32 will reliable bundle the light emitted by the light sources 23 in the vertical direction and direct it onto the cover 13. A distance of the focal point line from the light sources 23 in the horizontal and vertical direction and an inclination of the parabolic axis relative to the horizontal plane can be used to influence a bundling or fanning out as well as an elevation e of the main radiation direction.

The optical element can also comprise a plurality of individual optics 51, each of which is assigned to a single light-emitting diode (LED) 50 serving as a light source (FIG. 5). The individual optics 51 can comprise a transparent body 52, which comprises several support nubs 53 and a receiving cavity 54 on the underside. Inner wall surfaces 55, 56 of the receiving cavity 54 and outer wall surfaces 57, 58 of the body 52 form interfaces for the light emitted by the LED 50 and are shaped in such a way that the light emitted by the LED 50 is deflected in a desired direction. For example, in so-called side emitter optics, the light emitted by the LED 50 received in the receiving cavity 54 can be refracted in such a way that it is directed into a narrow vertical angular range around the horizontal plane H. In this case, the inner wall surfaces 55, 56 and the outer lateral wall surface 58 can essentially act as diffraction surfaces (with physically unavoidable partial reflection), while an upper outer wall surface 57 in the form of a funnel-shaped depression can be formed in such a way that essentially total reflection of the light emitted upwards and transmitted through the upper inner Wall surface 56 and its deflection to the side takes place there.

For mounting, the LED 50 is inserted into the mounting cavity 54 from below in the direction of arrow 59 or the single optic 51 is placed on the LED 50 in the opposite direction. The support nubs 53 make contact with a surface 60, for example, a surface 60 of the base 14 on which the LED 50 is mounted (FIG. 6). Individual optics 51 of this type therefore act as a combined refractor reflector.

To understand the invention, the oblique passage of light through a transparent wall 70 with essentially smooth wall surfaces 71, 72 is first explained (FIG. 7). It is assumed that the wall 70 is optically denser than the surrounding medium.

A light beam 73 falls at a first angle of incidence E1, measured from the perpendicular L1 at the point of incidence, onto a wall surface 71, which is hereinafter also referred to as the first interface 71. According to the laws of geometrical optics, a part (generally the smaller part in the case of transparent materials) of the light is reflected at the first interface 71 at a first angle of incidence A1 (partial beam 74), while another part (generally the larger part in the case of transparent materials) penetrates into the wall 70 (partial beam 75). Since a transition takes place from an optically thin medium to an optically denser medium, the light is refracted at a first refraction angle B1 toward the perpendicular L1. In other words, the first angle of refractive B1 with respect to the perpendicular L1, at which the partial beam 75 penetrates the wall 70, is smaller than the first angle of incidence E1. The first angle of projection or reflection A1 is equal to the first angle of incidence E1.

The penetrated partial beam 75 then strikes opposite wall surface at a second angle of incidence E2 from the local perpendicular L2, which is also referred to below as the second interface 72. In the case of parallel wall surfaces 71, 72, the second angle of incidence E2 is equal to the first angle of refraction B1. Again, a (smaller) part of the light is reflected at the second interface 72 at a second angle of incidence A2=E2 (partial beam 76), while another (larger) part escapes into the surroundings (partial beam 77). As a transition from an optically dense medium to an optically thinner medium takes place, the light is diffracted away from the perpendicular L2 at a second angle of refraction B2. In other words, the second angle of refractive B2 with respect to the perpendicular L2, at which the partial beam 77 escapes from the wall 70, is greater than the second angle of incidence E2. As a result of this process, the escaped partial beam 77 is offset parallel to an imaginary straight beam 78, which is a straight extension of the original light beam 73.

The partial beam 76 reflected back into the wall at the second interface 72 hits the first interface 71 again, where it is partly reflected back into the wall 70 (partial beam 75′) under the same angular conditions as the partial beam 75 that has penetrated the wall and hit the second interface 72 and partly escapes from the wall 70 under diffraction away from the perpendicular (partial beam 74′). This can be repeated several times at the interfaces 71, 72, whereby further partial beams 76′, 77′, 74″, 75″ can be formed.

It should be noted that the proportion of reflected light is low for common bodies perceived as transparent, whereby it is lowest at vertical incidence (E1=0) and increases with increasing angle of incidence E1. For the perpendicular incidence of visible light from air in normal glass, the reflected proportion can be, for example, 4% (at each boundary surface); with oblique incidence, the reflected proportion can increase to, for example, 5%. Depending on the glass, a further 2 to 9% can be lost over the length of run due to absorption. Apart from the length of run, the degree of absorption can be highly dependent on the material and the wavelength.

The extent of deflection due to refraction depends on the refractive indices of the body and the surrounding medium. For each passage through an interface, n1 sin(E)=n2 sin(B), where n1 is the refractive index of the first medium (on the incident side) relative to vacuum, n2 is the refraction index of the second medium, E is the angle of incidence and B is the angle of refraction, and E and B are measured relative to the perpendicular. For example, the refractive index with respect to vacuum is 1.000292 for air, i.e., approximately 1, 1.46 for quartz glass, up to 1.76 for high refractive spectacle glass, up to over 1.9, 1.58 for polystyrene glass and 1.585 for polycarbonate, and 1.492 for acrylic glass (PMMA).

The passage of light through a cylindrical wall 86, which may correspond to the transparent body of the cover 13 of the lighting device 10, is now considered (FIG. 8). Like the previously considered flat wall 70, the cylindrical wall 86 has a first (in this case inner) interface 87 and a second (in this case outer) interface 88. The first, inner interface surface 87 limits the internal space 12 of the lighting device 10. For simplification, only a single light source 23 is assumed, which is arranged eccentrically in the internal space 12.

The light source 23 can emit its light around. For simplification, only a radial beam 80, which strikes the first interface 87 perpendicular and a lateral beam 81, which strikes the first interface 87 at an angle of incidence E1 to the perpendicular, which here corresponds to a first radius R1. In fact, of course, an infinite number of lateral rays occur, each with different angles of incidence.

The vertical beam 80 passes straight through the cylindrical wall 86 for the most part, i.e. unbroken, while a small part is reflected at the interfaces 87, 88 according to the prevailing degree of reflection and an equally small part is absorbed within the cylindrical wall 86.

Part of the lateral beam 81 is reflected back into the interior 12 at the first interface 87 (partial beam 82), the emergent angle A1 corresponds to the angle of incidence E1. The other part is refracted at a first refraction angle B1 toward radius R1 (partial beam 83). The partial beam 83 refracted at the first interface 87 falls at the intersection with a second radius R2 at a second angle of incidence E2 on the second, outer interface 88. Due to the curvature of the wall 86, the second angle of incidence E2 is smaller than the first angle of refraction B1 at which the partial beam 83 enters the wall 86. This contrasts with the flat wall 70, where the second angle of incidence E2 at the second interface 72 is identical to the first angle of refraction B1 at the first interface 71.

The partial beam 83 is now partially reflected back into the wall 86 at the second interface 82 (partial beam 84), whereby the second emergent angle A2 corresponds to the second angle of incidence E2, and partially escapes from wall 86 by refraction towards the second radius R2 with a second angle of refraction B2 (partial beam 85). The partial beam 83 refracted at the second Interface 88 in the second radius R2 falls back onto the first, inner interface 87 at the intersection with a third radius R3 at a third angle of incidence E3. For reasons of symmetry, the third angle of incidence E3 corresponds to the first angle of refraction B1. Reflection occurs into a partial beam 83′ with the emergent angle A3=E3=B1 and refraction into a further partial beam 82′, which enters again into the interior 12, with the angle of refraction B3, which corresponds to the first angle of incidence E1 for reasons of symmetry (B3=E1). The further path of the partial beam 83′reflected into the wall at the first interface 87 at the intersection with the third radius R3 corresponds to that of the partial beam 83 refracted into the wall at the first interface 87 at the intersection with the first radius R1, with possible further iterations.

Back to the partial beam 82 reflected back into the internal space 12 at the first interface 87 at the intersection with the first radius R1, this falls onto the first interface 87 at a fourth angle of incidence E4 at an intersection with a fourth radius R4. Due to symmetry, E4=A1=E1, so the reflection and refraction angles and paths of this partial beam 82 repeat those of the original lateral light beam 81, offset by the angle between R4 and R1, possibly with further iterations (partial beams 82″, 83″).

The partial beam 82′refracted into the internal space 12 at the first interface 87 at the intersection with the third radius R3 meets the first interface 87 again at the intersection with a fifth radius R5 at a fifth angle of incidence E5. Due to symmetry, E5=B3=E1 applies again, so the further path corresponds to that of the original lateral light beam 81, offset by the angle between R5 and R1, possibly with further iterations (partial beams 82″, 83″).

Overall, the multiple reflections and refractions on the internal spaces 87 and the outer surface 88 of the wall 86, combined with the paths within the wall 86, can result in considerable losses in the light output. Furthermore, the punctual light sources 23 can be perceived clearly separated from each other from the outside, which is expressed in figures in a ripple in the light intensity of the light emitted to the outside over azimuth a.

The above observation was made for horizontal light beams striking the wall 86 perpendicularly in the vertical plane. In the case of beams that fall on the cover 13 at an angle to the horizontal plane H, the beams reflected back into the internal space 12 can also be reflected at the base 14 or the cover plate 21 (FIGS. 2, 3), as a result of which a scattering of certain portions of the light from the desired vertical angle range can occur.

According to the invention, a frosting was therefore applied to the inner and/or outer surface of the wall 86 of the cover 13. A frosting is surface roughening with structures that are large enough to have a scattering effect on the light used, but not so large that they would bundle or defocus the light and thus function as an optical imaging element themselves. This measure can effectively suppress reflections at the interfaces 87, 88. The appropriate dimension of the structures in the surfaces produced by the frosting is generally dependent on the wavelength of the light. If the structures are much smaller than the wavelength of the incident light, they will have no or negligible effect. If the dimension of the structures approaches the wavelength of the light or becomes larger, the structures will increasingly function as independent optical imaging elements. In this respect, this is undesirable in the context of the invention, unless other desired effects can be achieved.

According to the invention, frosted covers 13 were compared in measurements with a comparative example in which the cover 13 is clear, i.e. the surfaces are smooth within the limits of the manufacturing process. Six light sources 23 in the form of LEDs 50 of the type OSRAM OSLON SSL 80 with individual optics 51 (side emitter optics) of the type FRAEN F360L-3C-S (cf. FIGS. 5, 6) were arranged on a circle with a diameter 2 r of 50 mm on a flat base 14 (cf. FIG. 3 or 4(b)). The LEDs 50 of the selected type each comprise a wavelength of 730 nm, further properties can be found in the data sheet “GF CS8PM2.24” from the manufacturer OSRAM Opto Semiconductors GmbH, Regensburg, Germany, 29.8.2016. The individual optics 51 of the selected type, the structure of which is shown in FIGS. 5 and 6, each comprise a radiation peak at an elevation e of 19-21° for white light, further properties can be found in the data sheet “F360L-3C-S for Rebel/Rebel ES, Rev 02” from the manufacturer FRAEN Corporation OMG, Reading MA, USA and respectively FRAEN Corporation Srl, Trivolzio (PV), Italy, 2013. A cover 13 made of acrylic glass in the form of a cylindrical tube with an internal diameter d of 70 mm and a wall thickness T of 12 mm was arranged concentrically around the LEDs on the base 14.

The results of a measurement in the horizontal plane above 360° in steps of 5° azimuth are shown in FIG. 9 in a diagram 900 as case (a). In diagram 900, the azimuth angle a is plotted in degrees on the abscissa 901 and the measured light intensity in candela (cd) is plotted on the ordinate 902. The light intensity determined in an angular interval of 5° azimuth is shown as a column 903. The arithmetic mean value is shown as a solid line 904. The positions of the individual LEDs are clearly recognizable, the fluctuations, i.e., the ripple, are pronounced.

The same measurements were carried out under otherwise identical conditions with covers made of the same material with the only difference that the cover has a frosting on the inside (case (b) in FIG. 9), on the outside (case (c) in FIG. 9), or on both sides (case (d) in FIG. 9). The success of the measure is immediately apparent. Even with simple internal frosting (b), the waviness decreases and the average value increases. This effect is even more pronounced with simple external frosting (c). With double-sided frosting, a further increase in the average light output, but a significantly lower waviness, can be observed. Comparable results were also obtained for other elevation angles e.

For the measurements shown, the frosting was applied using a cylindrical lamellar grinding roller with 120 grit clamped in a drilling machine. The frosting can therefore comprise a preferred direction in the horizontal direction. The effect of the invention can also be demonstrated if the frosting is applied by grinding in vertical direction or by sandblasting without a preferred direction. Optimized frosting processes, in particular about the shape, dimension and preferred direction of the structures produced, can probably further improve the effects, and adapt them to preferred parameters. For example, scattering phenomena in the horizontal or vertical direction can be specifically increased or decreased by introducing a preferred direction.

The invention has been explained above with reference to selected embodiments. It is understood that the invention is not limited to the embodiments shown but is defined solely by the attached independent claims in their broadest interpretation. Individual features of the embodiments may be omitted without leaving the scope of protection of the invention, if the features defined in the independent claims are fulfilled. Individual features of several embodiments can be combined as desired within the scope of the invention if this is not technically impossible. For example, a reflector 30 can also be used for a dome-shaped cover, as shown in FIG. 4, as shown in FIG. 3 for a cylindrical cover. Conversely, LEDs 50 with individual optics 51 can also be used as light sources 23 for a cylindrical cover, as shown in FIG. 3, and for a bell-shaped cover as shown in FIG. 4.

The light sources 23 have been described above, which radiate at least approximately hemispherical or by means of custom individual optics 51 in the horizontal plane H, but in any case all around in the azimuthal direction a. Light sources 23 can also be used, which only cover a partial area in the azimuthal direction a, but the invention only develops its optimum effect when the azimuthal radiation areas of the light sources 23 overlap.

The invention is also not limited to lighting devices 10 with a single lighting unit 11. It is equally applicable to lighting devices with a single lighting unit 11 stacked in the vertical direction on several horizontal planes H1, H2, H3, (FIGS. 10(a), 11(a), (c)). Each lighting unit 11 can form a module with its own cover 20, whereby several modules can be stacked on top of each other. There may also be fewer than six, for example three, light sources 23 per lighting unit 11 (FIG. 10(b)) or considerably more (FIGS. 11(a), (c)).

The horizontal cover does not have to be complete but can also only be 180° for partial lights (FIGS. 11(a)-(c)). The light sources 23 of a lighting unit 23 do not necessarily have to be arranged on a flat surface. The base 14 may also comprise one or more cylindrical surfaces 1100, in particular one per lighting unit 11, on which the light sources 23 are arranged directed radially outwards (FIGS. 11(a), (c)).

A plurality of modules may be secured together and to a lowermost base 14 by a central screw 22 (FIG. 10(a)) or secured together by an eccentric through bolt 1101 and by other means to a heat sink 1102 (FIGS. 11(a)-(c)). The heat sink 1102 may be attached or attachable to a structure or a junction box or the like by means of angle brackets 1103. The central screw also provides good heat dissipation to the heat sink 1102.

In all these designs, the described effects can be achieved by the frosting according to the invention.

In further modifications, the internal space 12 inside the cover 13 can be filled with a translucent potting compound (not shown in detail). The potting compound can enclose the light sources. If necessary, the potting compound can also enclose the base 13 on which the light sources 23 are arranged. Such a potting compound can prevent water or moisture or other foreign substances from penetrating into the interior of the cover 11 even more effectively, which can extend the service life of the light sources 23 and also improve operational safety even under harsh environmental conditions. In the encapsulated form, it is also possible to use the lighting device 10 in the offshore area or even under water. Due to the thermal conductivity of the potting compound, the heat generated at the light sources 23 and the electronics can also be dissipated. As a result, any heat sinks can also be made smaller or omitted. Because the cover 23 is also heated via potting compound fogging and/or frost formation on the cover 23 can be prevented, which can also make an additional heating, which is conventionally often provided, unnecessary. In some applications, a mass gain (weight gain) of the lighting device 10 due to the potting compound may also be desirable, for example in terms of improved stability or inertia.

The potting compound can be solid overall but have an elasticity or toughness that minimizes stresses and strains on the light sources 23 and the cover 11, even under thermal loads or external influences.

It should be noted that the potting compound, even though it does not consist of air, forms the internal space 12 in the sense of the invention and the first interface 87 is also formed between this and the cover 11. Even if the potting compound has a considerable higher refractive index than air, the described phenomena can nevertheless occur, irrespective of whether the refractive index of the potting compound is greater than, less than or equal to the refractive index of the cover 11.

Some potting compounds are known, which are translucent and have also been developed for use on the used light sources 23, in particular on LEDs. For example, a suitable potting compound is offered by the company Electrolube under the trade name UR5634, which is produced on a polyurethane basis and has a resin and a hardener and is crystal clear. Another potting compound from the same company on the same basis is offered under the trade name UR5635 and has a hazy/cloudy, translucent appearance like frosted glass. Together with the frosting according to the invention, a crystal-clear potting compound achieves similar advantages to those described herein, with a milky potting compound the uniformity of the luminous effect, i.e. the uniformity of the luminous intensity over the circumference, can be further improved, if necessary, but the overall luminous efficacy can decrease. The other advantageous effects of the potting compound, such as heat dissipation, frost protection, encapsulation and weight, are achieved independently of this. The potting compounds mentioned are only mentioned as examples and are not intended to restrict the application in any way.

Even if it is assumed that the cover filled with the potting compound has the frosting described above in accordance with the invention, a milky opaque potting compound alone, i.e. without the frosting in accordance with the invention, can also be used to achieve at least the same uniformity of light as with the frosting. The other advantages of the potting compound are achieved anyway, as described above.

It is also conceivable to manufacture the cover 11 entirely from the potting compound, i.e. to cast the light sources 23 together with the base in a mold, whereby the monolith formed by the potting compound then also acts as a cover 11. This can then be understood in such a way that an internal space 12 of the cover 11 is not filled with the potting compound, but the cover 11 with the internal space 12 is formed monolithically by the potting compound and the light sources 23 are covered by monolithic inclusion. In this case, there is no first interface between the internal space 12 and the cover 11, but only the second interface between the cover 11 and the ambient air. This can also be frosted as described above, particularly in the case of a crystal-clear potting compound, which also achieves the effects described.

If the lighting unit 11 is mounted directly on the housing 15, it is advantageous if the housing 15 is designed as a heat sink and is thermally coupled to heat sources of the lighting unit 11, such as the light sources 23, a printed circuit board on which the light sources 23 are arranged, via heat-conducting means. For this purpose, the housing 15 can be made of a material with good thermal conductivity and/or formed with a high thermal capacity. Advantageously, the housing 15 can take the form of a switch box known as made of aluminum or an aluminum alloy or steel or another metal or another metal alloy. The heat-conducting means may comprise, for example, the base 14 and/or the central screw 22 or eccentric through bolt 1101.

Optionally, a separate base 14 may be omitted and a printed circuit board with light sources 23 may be mounted directly on the housing 15. In other words, the base 14 can be integrated into the housing 15 or the housing 15 or a wall thereof can serve as the base of the lighting unit 11. If the housing 15 absorbs the heat generated by the lighting unit 11 in this way, heat sinks within the lighting unit 11 can optionally be dispensed with or can be designed to be smaller, so that they only serve, for example, as buffer storage and can therefore also be part of the heat conducting means. With such heat dissipation, overheating problems in the lighting unit 11 can be considerably reduced or completely avoided. Such heat dissipation via the housing 15 is not possible with a conventional plastic switch box.

A monitoring unit for the lighting unit 11 can be provided to detect and report a failure or malfunction of light sources 23. Current relays, for example, can be used for detection. Reed relays can be used particularly advantageously for detection. A reed relay contains spring-loaded contact tabs made of ferromagnetic material and a wound magnetic coil for generating an electromagnetic field which, with the appropriate strength, can deflect the contact tabs and either bring them into contact (closing relay) or out of contact (opening relay) or hold them. Compared to conventional switching relays, reed relays are comparatively inexpensive and can be manufactured individually. The winding of the reed relays is advantageously matched to the current of the lighting unit 11 or at each light source 23 and thus enables precise and reliable monitoring with reduced or completely avoided false alarms.

1. A lighting device, in particular a beacon or an obstruction light, having a base on which a group of a plurality of light sources is arranged in a horizontal plane (H), and a transparent cover which surrounds the light sources and is designed to protect the light sources from environmental influences, wherein at least some of the light sources are arranged eccentrically to a zenith axis (Z) orthogonal to the horizontal plane (H), which defines a vertical direction, and the cover comprises a frosted internal space and/or outer side.

2. Lighting device according to claim 1, wherein,
the light sources of the group of light sources are arranged on a circular line or partial circular line around the zenith axis (Z), preferably at equal angular intervals.

3. Lighting device according to claim 1, wherein,
the light sources of the group of light sources comprise overlapping radiation areas in the horizontal plane (H).

4. Lighting device according to claim 1,
wherein,
the light sources are designed in such way that they emit light over an angular range of at least 45° and in particular at least 90°.

5. Lighting device according to one of the preceding claim 1,
wherein,
the light sources are light-emitting diodes.

6. Lighting device according to claim 1,
wherein
the group of light sources comprises three or at least four, preferably six or eight, light sources.

7. Lighting device according to claim 1,
wherein,
the light sources or the lighting device emit a total of red light in a wavelength range of at least 605 nm and not more than 780 nm and/or infrared light in a wavelength range of at least 780 nm and not more than 3000 nm or not more than 1000 nm.

8. Lighting device according to claim 1,
wherein,
an optical element provided for directing the light emitted by the light sources onto the cover, which is designed to focus the light into the vertical direction, wherein the optical element
is a plurality of individual optics, wherein each individual optic is assigned to one of the light sources and is adapted to focus the light emitted by one of the light sources in the vertical direction, the individual optics covering and surrounding a light emitting region of one of the light sources, or
a common reflector or refractor designed to focus the light emitted by several or all of the light sources in the vertical direction.

9. Lighting device according to claim 1,
wherein,
the frosting of the cover is formed by sandblasting or compressed air blasting with another solid blasting abrasive or grinding or etching.

10. Lighting device according to claim 1,
wherein,
the frosting is formed with structures in the dimension of at least 0.1 μm and/or with structures in the dimension of not more than 3 μm or not more than 1 μm.

11. Lighting device according to claim 1,
wherein,
the frosting is directed in the vertical direction or in the horizontal direction.

12. Lighting device according to claim 1,
wherein,
a plurality of groups of light sources are provided, each arranged in a horizontal plane (H1, H2, H3; H1-HN), the horizontal planes (H1, H2, H3; H1-HN) of the groups being spaced parallel along the zenith axis (Z).

13. Lighting device according to claim 1,
wherein,
the base comprises a surfaceformed along the horizontal plane (H), on which the light sources of the or a group of light sources are arranged.

14. Lighting device according to claim 1,
wherein,
the base comprises a cylindrical or part-cylindrical surface formed along the zenith axis (Z) or a plurality of flat surfaces formed parallel to the zenith axis (Z), on which the light sources are arranged.

15. Lighting device according to claim 1,
wherein,
the cover is made of a polyacrylic or polycarbonate or polymethyl methacrylate or polymethacrylmethylimide or polystyrene or styrene-acrylonitrile copolymer or cycloolefin copolymer or quartz glass or another mineral glass.

16. Lighting device according to claim 1,
wherein,
an internal space within the cover is filled with a translucent potting compound, the potting compound enclosing particularly the light sources and/or the base.
